(19) United States
(12) Patent Application Publication
(10) Pub. No.: US 2011/0176327 A1
(43) Pub. Date: Jul. 21, 2011

(54) Planar lighting device and a method of producing the same

(75) Inventor: Osamu Iwasaki, Kanagawa (JP)

(73) Assignee: FUJIFILM Corporation, Tokyo (JP)

(21) Appl. No.: 12/929,361

(22) Filed: Jan. 19, 2011

(30) Foreign Application Priority Data
Jan. 20, 2010 (JP) 2010-009878

(51) Int. Cl. F21V 8/00

(52) U.S. Cl. 362/606

(57) ABSTRACT

A planar lighting device in which transmittance adjusting members are not provided in a region extending a distance of Lmfp from an end of the light guide plate closer to the light entrance plane in a direction normal to the light entrance plane, where Lmfp is a mean free path of luminous flux emitted from the light source and admitted in the light guide plate through the light entrance plane.

### BACKGROUND OF THE INVENTION

The present invention relates to a planar lighting device used for a liquid crystal display device and the like and a method of manufacturing the same.

### BACKGROUND ART

Liquid crystal display devices use a backlight unit for radiating light from behind the liquid crystal display panel to illuminate the liquid crystal display panel. A backlight unit is configured using a light guide plate for diffusing light emitted by an illumination light source to irradiate the liquid crystal display panel and optical parts such as a prism sheet and a diffusion sheet for rendering the light emitted from the light guide plate uniform.

Currently, large liquid crystal televisions predominantly use a so-called direct illumination type backlight unit comprising a light guide plate disposed immediately above the illumination light source. This type of backlight unit comprises a plurality of cold cathode tubes serving as a light source provided behind the liquid crystal display panel whereas the inside of the backlight unit provides white reflection surfaces to ensure uniform light amount distribution and necessary luminance.

To achieve a uniform light amount distribution with a direct illumination type backlight unit, however, a thickness of about 30 mm in a direction normal to the liquid crystal display panel is required, making further reduction of thickness of the backlight unit difficult using the direct illumination type backlight unit.

Among backlight units that allow reduction of thickness thereof, on the other hand, is a backlight unit using a light guide plate in which light emitted by an illumination light source and entering the light guide plate through a light entrance plane is guided in given directions and emitted through a light exit plane that is different from the plane through which light enters.

There has been proposed a backlight unit of a type in the form of a plate using a light guide plate having a pattern formed on its top surface or the opposite surface thereof for emitting light, wherein light is admitted through a lateral side thereof and allowed to exit through the top surface or a backlight unit of a type using a light guide plate containing scattering particles for diffusing light mixed in a resin, whereby light is admitted through a lateral side and allowed to exit through the top surface.

JP 2009-75606 A, for example, describes a planar light emitting device comprising a reflection member provided so as to cover at least one plane of the light guide plate other than the light entrance plane and the light exit plane and a display panel provided over the whole surface of the exit plane of the light guide plate to pass emission light through the whole light exit plane and display a given desired pattern, wherein at lease one of the light exit plane and the plane opposite the light exit plane has a light scattering surface, which is a finely finished roughened surface.

JA 2006-294256 P describes a light guide unit for a planar light source device wherein one of the light exit plane and the plane on the reverse side opposite therefrom has formed thereon arrays of corrugation structure extending substantially in a direction of directivity of the light entering the light guide unit in a plane parallel to the light exit plane and arranged parallel to each other and wherein a strip of flat portion is formed extending parallel to the light entrance end face in at least a part of a region from a region in contact with the light entrance end face to a region of an effective light emission region in the plane where the arrays of corrugation structure are formed.

JP 2004-6187 A describes a planar light source device provided with a number of prism projections extending in a direction away from the light entrance plane side and arranged parallel to each other along the light entrance plane in such a manner that the height of the prism projections gradually decrease from the light entrance plane toward the opposite side.

JP 2009-117349 A describes a planar lighting device comprising a light guide plate including a rectangular light exit plane having a concave surface, two light entrance planes including two opposite longer sides of the light exit plane and located opposite each other, two symmetrical inclined planes such that their distance from the light exit plane increases with the increasing distance from the two light entrance planes toward the center of the light exit plane, and a curved portion connecting the two inclined planes, the light guide plate containing scattering particles for scattering the light propagating therein.

JP 2009-117357 A describes a light guide plate containing scattering particles dispersion therein for scattering light and comprising a first layer located on the side closer to the light exit plane and a second layer located on the side closer to the rear plane and having a higher particle density than the first layer.

JP 2008-204874 A describes a configuration of a light guide plate containing scattering particles wherein a plurality of diffusion reflectors arranged on the rear plane of the light guide plate in a given pattern and another configuration of a light guide plate comprising transmittance adjusting members composed of a number of transmittance adjusters formed of dots varying in size and having a given transmittance, arranged on a transparent film on the side of the light guiding plate closer to the light exit plane.

As liquid crystal display devices acquire increased dimensions, there are increasing demands for larger backlight units as described above. Accordingly, there have been proposed various backlight units as described above including those of a type having a pattern formed on its top surface or the opposite surface thereof for emitting light, wherein light is admitted through a lateral side thereof and allowed to exit through the top surface or those of a type using a light guide plate containing scattering particles for diffusing light mixed therein, whereby light is guided in a direction different from the direction in which the light has entered and allowed to exit through the light exit plane. Thus, providing a light source on a lateral side of the light guide plate enables reduction in dimensions and weight as compared with backlight units having a light source provided on the reverse side of the light guide plate.

However, when a backlight of a type having a pattern formed on its top surface or the opposite surface therefrom for emitting light is to be made thinner and larger, there arises a need to reduce the pattern arrangement density in order to guide the light deep into the light guide plate, and this often results in relatively increasing the luminance in the vicinity of the light entrance plane. In addition, the reduction in pattern arrangement density permits light to be emitted without sufficient diffusion in the vicinity of the light entrance plane, which increases unevenness in luminance of the emitted light.

JP 2006-294256 A, JP 2004-6187 A, and JP2009-117349 A describe controlling the luminance of emitted light in the vicinity of the light entrance plane and reducing luminance variation by making the surface bearing the pattern a flat surface close to the light entrance plane.

Further, with a backlight unit of a type using a light guide plate containing scattering particles, there arises a need to reduce the scattering particle density in order to guide the light deep into the light guide plate. However, a reduced thickness and an enlarged size relatively lower the luminance at the central area of the light guide plate while also reducing the light emission efficiency.

Thus JP 2008-204874 A proposes providing the diffusion reflectors arranged in a given pattern or the transmittance adjusting members arranged on a transparent film on the side of the light guide plate, which contains scattering particles, closer to the rear plane or the light exit plane to adjust the luminance distribution of the emitted light and improve the luminance in the central area in order to obtain a flat luminance distribution or a luminance distribution that is high in a range near the middle.

### SUMMARY OF THE INVENTION

However, when a part of the pattern-bearing surface is made flat near the light entrance plane as described in JP 2006-294256 A, JP 2004-6187 A, and JP2009-117349 A, the light emitted from the flat surface or a region close to the flat surface, where light is not diffused, exhibits increased unevenness in luminance caused by light sources disposed at intervals among other reasons, making it impossible to achieve uniform illumination.

Further, with a configuration wherein the light guide plate containing scattering particles dispersed therein is also provided with the pattern on the top surface or the opposite side thereto, the luminance in a region close to the light entrance plane relatively increases, although such a configuration provides increased freedom in adjusting the luminance distribution of the emission light emitted from the light guide plate. Further, because the pattern is provided close to the light entrance plane, the light is emitted without sufficient diffusion, and hence the unevenness in luminance increases, making it impossible to achieve uniform illumination.

An object of the present invention is to provide a planar lighting device using a large and thin light guide plate and yet capable of yielding a high light use efficiency, emitting light with a minimized unevenness in luminance, and guiding the admitted light deep into the light guide plate to achieve a luminance distribution that is high in a range near the middle, thereby overcoming the problems associated with the prior art described above.

The present invention enables emission of light with a high light use efficiency and minimized unevenness in luminance and guidance of the admitted light deep into the light guide plate, achieving luminance that is evenly distributed or a luminance distribution that is uniform or high in a range near the middle.

### BRIEF DESCRIPTION OF THE DRAWINGS

FIG. 1 is a schematic perspective view illustrating an embodiment of a liquid crystal display device using the planar lighting device of the invention.

FIG. 2 is a cross sectional view of the liquid crystal display device illustrated in FIG. 1 taken along line II-II.

FIG. 3A is a top plan view illustrating, partially omitted, light sources, a light guide plate, and transmittance adjusting members of the planar lighting device of FIG. 2; FIG. 3B is a cross sectional view of FIG. 3A taken along line B-B.

FIG. 4 is a perspective view illustrating the shape of the light guide plate of FIG. 3.

FIGS. 5A and 5B are schematic sectional views illustrating other examples of the light guide plate used in the invention.

FIG. 6 is a graph illustrating measurements representing a relationship between Φ·Nₚ·L_{G}·K_{C} and light use efficiency.

FIG. 7 is a graph illustrating measurements representing illuminance of light emitted by light guide plates each having different particle densities.

FIG. 8 is a graph illustrating relationships between light use efficiency and unevenness in illuminance on the one hand and particle density on the other.

FIG. 9 is a perspective view illustrating the schematic configuration of a light source of the planar lighting device of FIG. 2.

FIG. 10 is a graph illustrating a relationship between the mean free path and the radius of scattering particles and the particle density.

FIG. 11 is a graph illustrating measurements of relative illuminance distributions of light emitted through the light exit plane of the backlight unit.

FIG. 12 is a cross sectional view schematically illustrating another example of the backlight unit.

FIG. 13 is a cross sectional view illustrating, partially omitted, the light sources, the light guide plate, and the transmittance adjusting members of the backlight unit of FIG. 12.

### DETAILED DESCRIPTION OF THE INVENTION

Now, the planar lighting device of the invention will be described in detail below referring to preferred embodiments illustrated in the accompanying drawings.

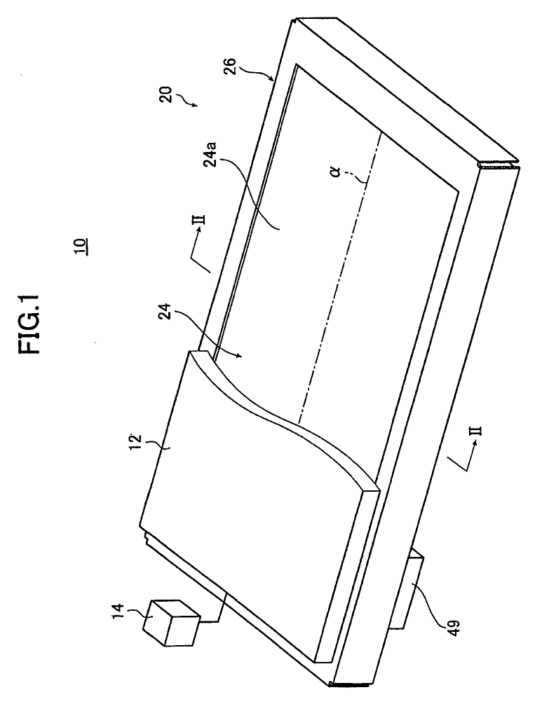

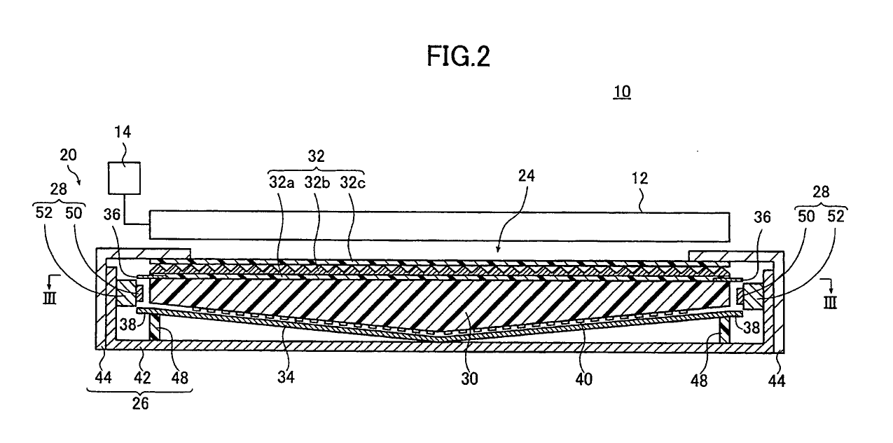

FIG. 1 is a schematic perspective view illustrating a liquid crystal display device provided with the planar lighting device of the invention; FIG. 2 is a cross-sectional view of the liquid crystal display device illustrated in FIG. 1 taken along line II-II.

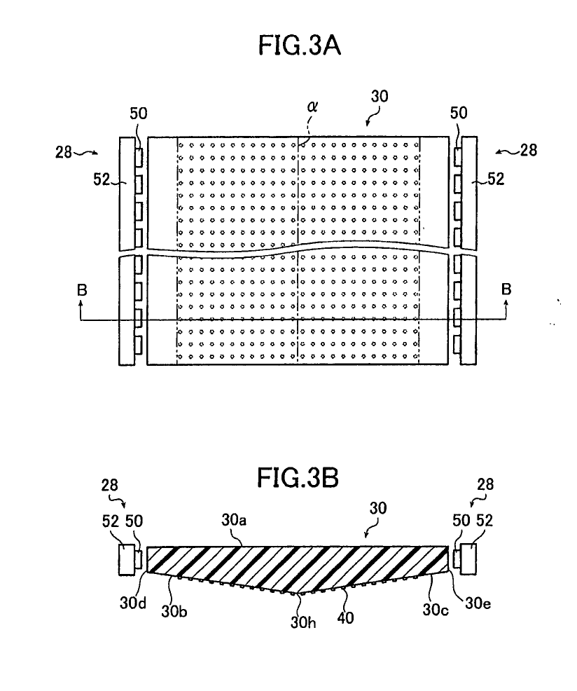

FIG. 3A is a view of an example of the planar lighting device (also referred to as “backlight unit” below) illustrated in FIG. 2 taken along line FIG. 3B is a cross sectional view of FIG. 3A taken along line B-B.

A liquid crystal display device 10 comprises a backlight unit 20, a liquid crystal display panel 12 disposed on the side of the backlight unit closer to the light exit plane, and a drive unit 14 for driving the liquid crystal display panel 12. In FIG. 1, a part of the liquid crystal display panel 12 is not shown to illustrate the configuration of the backlight unit.

In the liquid crystal display panel 12, an electric field is partially applied to liquid crystal molecules, previously arranged in a given direction, to change the orientation of the molecules. The resultant changes in refractive index in the liquid crystal cells are used to display characters, figures, images, etc., on the liquid crystal display panel 12.

The drive unit 14 applies a voltage to transparent electrodes in the liquid crystal display panel 12 to change the orientation of the liquid crystal molecules, thereby controlling the transmittance of the light transmitted through the liquid crystal display panel 12.

The backlight unit 20 is a lighting device for illuminating the whole surface of the liquid crystal display panel 12 from behind the liquid crystal display panel 12 and comprises a light exit plane 24a having substantially a same shape as an image display surface of the liquid crystal display panel 12.

As illustrated in FIGS. 1, 2, 3A and 3B, this embodiment of the backlight unit 20 comprises a main body of the lighting device 24 and a housing 26. The main body of the lighting device 24 comprises light sources 28, a light guide plate 30, an optical member unit 32, a reflection film 34, an upper guiding reflection film 36, a lower guiding reflection film 38, and transmittance adjusting members 40. The housing 26 comprises a lower housing 42, an upper housing 44, and support members 48. As illustrated in FIG. 1, a power unit casing 49 is provided on the underside of the lower housing 42 to hold power supply units that supply the light sources 28 with electrical power.

Now, component parts constituting the backlight unit 20 will be described.

The main body of the lighting device 24 comprises the light sources 28 for emitting light, the light guide plate 30 for admitting the light emitted by the light sources 28 to produce planar light, the optical member unit 32 for scattering and diffusing the light produced by the light guide plate 30 to obtain light with further reduced unevenness, numerous transmittance adjusting members 40 for emitting scattered light and reducing unevenness, the upper guiding reflection film 36 and the lower guiding reflection film 38 for efficiently admitting light emitted from the light source 28 into the light guiding plate 30, and the reflection film 34 for reflecting light leaking from the rear plane of the light guide plate and causing the light to re-enter the light guide plate 30.

First, the light guide plate 30 will be described.

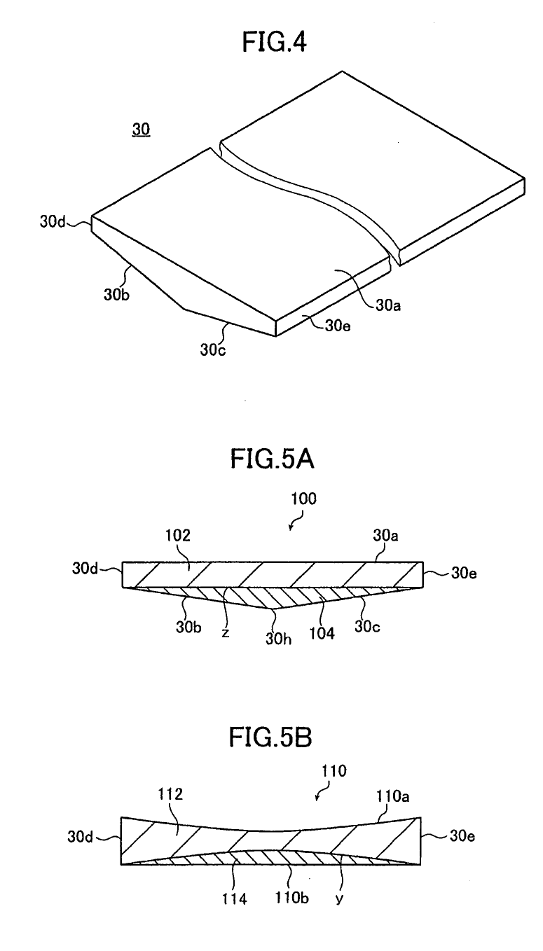

FIG. 4 is a perspective view schematically illustrating the shape of the light guide plate.

As illustrated in FIGS. 2, 3A, 3B, and 4, the light guide plate 30 comprises the rectangular light exit plane 30a; two light entrance planes, the first light entrance plane 30d and the second light entrance plane 30e formed on the two longer sides of the light exit plane 30a and substantially normal to the light exit plane 30a; and two inclined planes (a first inclined plane 30b and a second inclined plane 30c) located on the opposite side from the light exit plane 30a, i.e., on the underside of the light guide plate so as to be symmetrical to each other with respect to a central axis or the bisector α connecting the centers of the shorter sides of the light guide plate 30a (see FIGS. 1 and 3) and inclined a given angle θ with respect to the light exit plane 30a. The two inclined planes (first inclined plane 30b and second inclined plane 30c) are smoothly connected to each other by the curved portion 30h having a radius of curvature R.

The thickness of the light guide plate 30 increases from the first light entrance plane 30d and the second light entrance plane 30e toward the center such that the light guide plate 30 is thickest in a position thereof corresponding to the central bisector α and thinnest at the two light entrance planes (the first light entrance plane 30d and the second light entrance plane 30e) on both ends.

The inclination angle θ of the first inclined plane 30b and the second inclined plane 30c with respect to the light exit plane 30a is not specifically limited.

The light guide plate 30 is formed of a transparent resin into which light scattering particles are kneaded and evenly dispersed. Transparent resin materials that may be used to form the light guide plate 30 include optically transparent resins such as PET (polyethylene terephthalate), PP (polypropylene), PC (polycarbonate), PMMA (polymethyl methacrylate), benzyl methacrylate, MS resins, and COP (cycloolefin polymer). The scattering particles kneaded and dispersed into the light guide plate 30 may be formed, for example, of fine particles including silicone particles such as TOSPEARL (trademark), silica particles, zirconia particles, or dielectric polymer particles.

Although the light guide plate according to this embodiment is shaped like a reversed wedge such that the thickness decreases from the light entrance planes (30d, 30e) toward the center, the configuration is not limited this way; the light guide plate may be shaped like a flat sheet. Although the light exit plane of the light guide plate is a flat plane, it is not limited thereto and may be a concave plane. Should the light guide plate contract due to heat and humidity, the configuration of the light exit plane in the form of a concave plane prevents the light guide plate from warping toward the light exit plane and touching the liquid crystal display panel.

According to this embodiment, the particle density of the scattering particles kneaded and dispersed into the light guide plate are evenly dispersed in the light guide plate as described above, but this is not the sole case; the light guide plate may comprise a plurality of layers containing scattering particles with different particle densities.

FIGS. 5A and 5B are schematic sectional views illustrating other examples of light guide plate used in the present invention.

A light guide plate 100 illustrated in FIG. 5A comprises a first layer 102 on the side of an interface z closer to the light exit plane 30a and a second layer 104 on the side of the interface z closer to the rear plane 30c, the interface z connecting the ends of the light entrance planes (30d, 30e) bordering on the rear plane. The scattering particles are so dispersed that the second layer 104 has a higher particle density than the first layer 102. The light guide plate, comprising a plurality of layers containing scattering particles with different densities, is capable of emitting illumination light having a convex luminance distribution with a minimized unevenness in luminance and illuminance through the light exit plane 30a and yielding an increased light use efficiency.

A light guide plate 110 illustrated in FIG. 5B, shaped like a flat sheet, has a concave light exit plane and comprises two layers containing scattering particles with different densities.

The light guide plate 110 has a rear plane 110b formed into a flat plane and a light exit planes 110a formed into a concave plane approaching the rear plane 110b with the increasing distance from the light entrance planes (30d, 30e). The light guide plate 110 comprises a first layer 112 on the side of an interface z closer to a light exit plane 110a and a second layer 114 on the side closer to the rear plane 110b, the interface z being a curved plane so shaped as to connect the sides of the light entrance planes (30d, 30e) bordering on the rear plane 110b and be distanced farther from the rear plane 110b from the light entrance planes toward the center of the light guide plate 110. The scattering particles are so dispersed that the second layer 104 has a higher particle density than the first layer 102.

Thus, the light guide plate formed into a flat sheet can be adapted to have larger light entrance planes and yield an increased light use efficiency. Further, the two-layer structure having different particle densities such that the thickness of the second layer having a higher particle density increases from the light entrance planes toward the center of the light guide plate enables a luminance distribution that is high in a range near the middle to be achieved even when the light guide plate has the form of a flat sheet.

To emit light exhibiting a luminance distribution that is high in a range near the middle from the light exit plane, use of a light guide plate as described below is also preferable.

Now, let Φ be a scattering cross section of the particles contained in the light guide plate 30; L_{G} a light guiding length in the incident direction, which is the distance between the light entrance planes of the light guide plate according to this embodiment; Nₚ a density of the scattering particles contained in the light guide plate 30 (number of particles per volume); and K_{c} a compensation coefficient. Then, the scattering particles preferably satisfy a relationship where the value of Φ·N_{P}·L_{G}·K_{C} is greater than or equal to 1.1 and less than or equal to 8.2, and the value of the compensation coefficient KC is greater than or equal to 0.005 and less than or equal to 0.1. The light guide plate 30, containing scattering particles satisfying the above relationship, is capable of emitting uniform illumination light through the light exit plane with a greatly reduced level of unevenness in luminance.

When parallel rays of light are caused to enter an isotropic medium, a transmittance T is generally expressed according to the Lambert-Beer law by the following expression (1):

T=I/Io=exp(−ρ·x) (1)

where x is a distance, Io an intensity of incident light, I an intensity of outgoing light, and ρ an attenuation constant.

The above attenuation constant ρ can be expressed using the scattering cross section of particles ρ and the number of particles Nₚ in unit volume contained in the medium as follows:

ρ=Φ·Nₚ (2)

Thus, a light extraction efficiency Eₒᵤₜ is given by an expression (3) as below, where L_{G} is a half of the length of the light guide plate in its optical axis direction.

The light extraction efficiency is a ratio of light reaching the position spaced apart from the light entrance planes of the light guide plate 30 by the length L_{G} in the direction of the optical axis to the incident light. In the case of the light guide plate 30 illustrated in FIG. 2, for example, the light extraction efficiency is a ratio of light reaching the center of the light guide plate 30 or light traveling half the length of the light guide plate 30 in the direction of the optical axis to the light admitted through the light entrance planes.

Eₒᵤₜ∝exp(−ΦNₚ·L_{G}) (3)

Here, the expression (3) applies to a space of limited dimensions that introduces the compensation coefficient K_{C} therein for correcting the relationship with the expression (1). The compensation coefficient KC is a dimensionless compensation coefficient empirically obtained where light propagates through an optical medium of limited dimensions. Thus, a light extraction efficiency Eₒᵤₜ is given by an expression (4) as below.

Eₒᵤₜ=exp(−Φ·Nₚ·L_{G}·K_{C}) (4)

According to the expression (4), when Φ·Nₚ·L_{G}·K_{C} is 3.5, the light extraction efficiency Eₒᵤₜ is 3%. When Φ·Nₚ·L_{G}·K_{C} is 4.7, the light extraction efficiency Eₒᵤₜ is 1%.

The results show that the light extraction efficiency Eₒᵤₜ decreases as Φ·Nₚ·L_{G}·K_{C} increases. The light extraction efficiency Eₒᵤₜ decreases in such a manner presumably because light is scattered increasingly as it travels in the direction of the optical axis of the light guide plate.

It follows, therefore, that the greater the value Φ·Nₚ·L_{G}·K_{C} is, the more preferable it is as a property of the light guide plate. When Φ·Nₚ·L_{G}·K_{c} is great, light exiting through the plane opposite the light entrance plane can be reduced whereas light emitted through the light exit plane can be increased. Expressed otherwise, when Φ·Nₚ·L_{G}·K_{C} is great, the ratio of light emitted through the light exit plane 30a to the light entering the light entrance planes (also referred to as “light use efficiency” below) can be increased. Specifically, a light use efficiency as high as 50% or more is achieved when Φ·Nₚ·L_{G}·K_{C} is 1.1 or greater.

While light emitted through the light exit plane 30a of the light guide plate 30 increasingly exhibits unevenness in illuminance as Φ·Nₚ·L_{G}·K_{C} increases, the unevenness in illuminance can be held to under a given tolerable level by holding the value Φ·Nₚ·L_{G}·K_{C} to 8.2 or less. Note that illuminance and luminance can be treated substantially equally. Thus, it is assumed that luminance and illuminance possess similar tendencies in the present invention.

Thus, the value Φ·Nₚ·L_{G}·K_{C} of the light guide plate of the invention is preferably not less than 1.1 and not greater than 8.2, and more preferably not less than 2.0 and not greater than 7.0. Still more preferably, the value Φ·Nₚ·L_{G}·K_{C} is not less than 3.0 and, most preferably, not less than 4.7.

The compensation coefficient KC is preferably not less than 0.005 and not greater than 0.1.

Now, the light guide plate will be described in detail by referring to specific examples.

A computer simulation was conducted to obtain light use efficiencies for different light guide plates given different values of Φ·Nₚ·L_{G}·K_{C} by varying the scattering cross section, the particle density Nₚ, the length L_{G}, which is a half of the length of the light guide plate in the direction of the optical axis, and the compensation coefficient KC. Further, unevenness in illuminance was evaluated. The unevenness in illuminance (%) was defined as [(I_{Max}−I_{Min})/I_{Ave}]×100, where I_{Max} was a maximum illuminance of light emitted through the light exit plane of the light guide plate, I_{Min} a minimum illuminance, and I_{Ave} an average illuminance.

The measurement results are shown in Table 1. In Table 1, judgments “O” indicate cases where the light use efficiency is 50% or more and the unevenness in illuminance is 150% or less whereas judgments “X” indicate cases where the light use efficiency is less than 50% or the unevenness in illuminance is more than 150%.

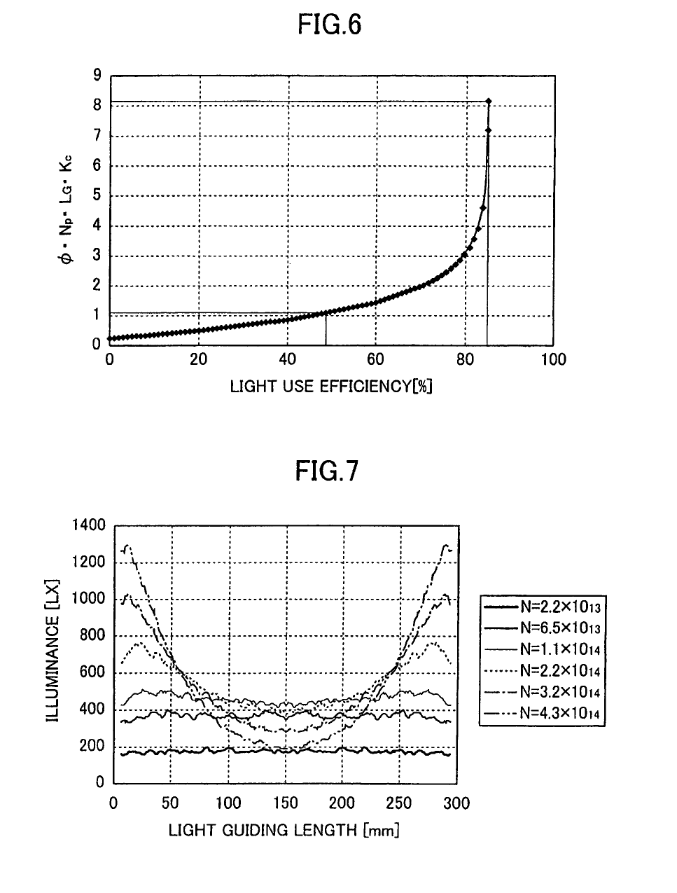

FIG. 6 illustrates a relationship between Φ·N_{P}·L_{G}·K_{C} and light use efficiency, i.e., the ratio of light emitted through the light exit plane to light admitted through the light entrance planes.

TABLE 1

| | | | | | | Light use | Illuminance | |
|---|---|---|---|---|---|---|---|---|
| | | | | | | efficiency | unevenness | |
| | Φ [m²] | Nₚ [pcs/m³] | L_{G} [m] | K_{c} | ΦNₚL_{G}K_{c} | [%] | [%] | Judgement |
| Reference 1 | 2.0 × 10⁻¹² | 2.2 × 10¹⁴ | 0.3 | 0.03 | 3.51 | 81.6 | 84 | Good |
| Reference 2 | 2.0 × 10⁻¹² | 4.3 × 10¹⁴ | 0.3 | 0.02 | 6.21 | 84.7 | 149 | Good |
| Reference 3 | 2.0 × 10⁻¹² | 8.6 × 10¹⁴ | 0.1 | 0.02 | 3.86 | 82.8 | 82 | Good |
| Reference 4 | 1.1 × 10⁻¹⁰ | 1.5 × 10¹³ | 0.3 | 0.01 | 3.91 | 83.0 | 105 | Good |
| Reference 5 | 1.1 × 10⁻¹⁰ | 2.0 × 10¹³ | 0.3 | 0.01 | 4.98 | 84.3 | 142 | Good |
| Reference 6 | 1.1 × 10⁻¹⁰ | 3.5 × 10¹³ | 0.1 | 0.01 | 2.86 | 79.2 | 47 | Good |
| Comparative example 1 | 2.0 × 10⁻¹² | 2.2 × 10¹³ | 0.3 | 0.05 | 0.66 | 29.1 | 51 | Bad |
| Comparative example 2 | 1.1 × 10⁻¹² | 2.5 × 10¹² | 0.3 | 0.01 | 0.99 | 43.4 | 59 | Bad |
| Comparative example 3 | 4.8 × 10⁻¹⁸ | 8.6 × 10¹⁷ | 0.1 | 15.2 | 6.26 | 84.8 | 201 | Bad |
| Comparative example 4 | 4.8 × 10⁻¹⁸ | 1.7 × 10¹⁸ | 0.1 | 13.9 | 11.5 | 84.9 | 225 | Bad |

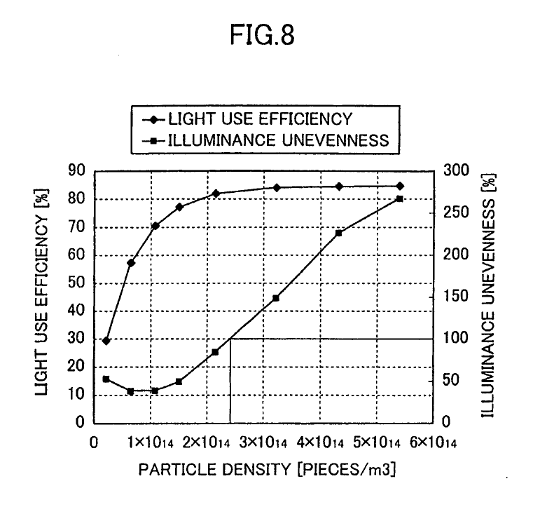

Table 1 and FIG. 8 show that given Φ·Nₚ·L_{G}·K_{C} of 1.1 or more, a high light use efficiency, specifically 50% or more, is achieved whereas given Φ·Nₚ·L_{G}·K_{C} of 8.2 or less, unevenness in illuminance can be held to 150% or less.

It is also shown that given K_{c} of 0.005 or more, a high light use efficiency is achieved, and given K_{c} of 0.1 or less, unevenness in illuminance observed in light emitted from the light guide plate can be minimized.

Next, light guide plates varying in particle density Nₚ of the particles kneaded or dispersed therein were fabricated to measure illuminance distributions of light emitted at different positions in the light exit plane of the individual light guide plates. In the embodiment under discussion, the conditions including scattering cross section, length L_{G}, which is a half of the length of the light guide plate in the direction of its optical axis, compensation coefficient K_{C}, and shape of the light guide plate, but excluding particle density Nₚ, were respectively set to fixed values as the measurements were made. In the embodiment under discussion, therefore, the value Φ·Nₚ·L_{G}·K_{C} changes in proportion as the particle density Nₚ changes.

FIG. 7 shows the measurements of the distribution of illuminance observed in the light emitted through the light exit plane of the individual light guide plates having different particle densities. FIG. 7 shows the illuminance [1×] on the vertical axis plotted against a light guiding length, which is the distance [mm] from one of the light entrance planes of the light guide plate on the horizontal axis.

Unevenness in illuminance was calculated from [(I_{Max}−I_{Min})/I_{Ave}]×100 [%], where I_{Max} is a maximum illuminance in the measured distribution of light emitted from areas of the light exit plane close to the lateral ends thereof, I_{Min} is a minimum illuminance, and I_{Ave} is an average illuminance.

FIG. 8 illustrates a relationship between the calculated unevenness in illuminance and particle density. FIG. 8 shows the unevenness in illuminance [%] on the vertical axis plotted against the particle density [pieces/m³] on the horizontal axis. Also shown in FIG. 8 is a relationship between light use efficiency and particle density, the particle density being likewise indicated on the horizontal axis and the light use efficiency [%] on the vertical axis.

As shown in FIGS. 7 and 8, increasing the particle density or, consequently, increasing Φ·Nₚ·L_{G}·K_{C}, results in an enhanced light use efficiency but then unevenness in illuminance also increases. The graphs also show that reducing the particle density or, consequently, reducing Φ·Nₚ·L_{G}·K_{C}, results in lowered light use efficiency but then unevenness in illuminance decreases.

A value Φ·Nₚ·L_{G}·K_{C} of not less than 1.1 and not greater than 8.2 yields a light use efficiency of 50% or more and unevenness in illuminance of 150% or less. Unevenness in illuminance, when reduced to 150% or less, is inconspicuous.

Thus, it will be understood that Φ·Nₚ·L_{G}·K_{C} of not less than 1.1 and not greater than 8.2 yields light use efficiency above a certain level and a reduced unevenness in illuminance.

Now, the light source 28 will be described.

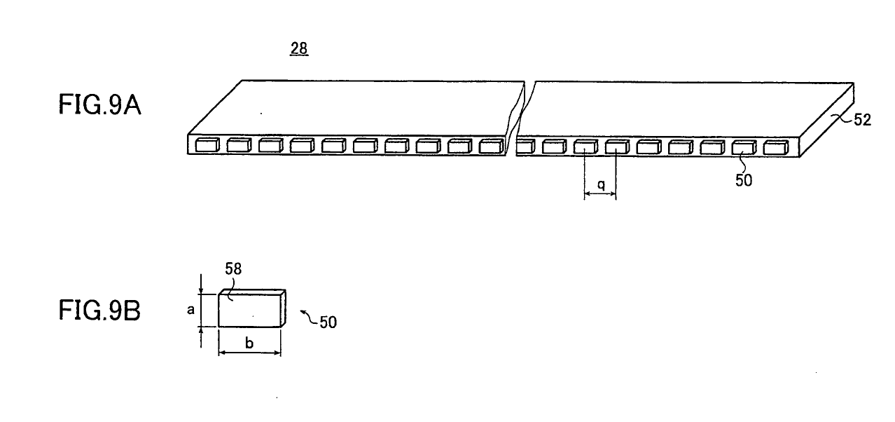

FIG. 9A is a perspective view schematically illustrating a configuration of a light source 28 of the backlight unit 20 of FIGS. 1 and 2; FIG. 9B is a schematic perspective view illustrating, enlarged, only one LED chip of the light source 28 of FIG. 9A.

As illustrated in FIG. 9A, the light source 28 comprises a plurality of light emitting diode chips (referred to as “LED chips” below) 50 and a light source mount 52.

The LED chip 50 is a chip of a light emitting diode emitting blue light the surface of which has a fluorescent substance applied thereon. It has a light emission face 58 with a given area through which white light is emitted.

Specifically, when blue light emitted through the surface of the light emitting diode of the LED chip 50 is transmitted through the fluorescent substance, the fluorescent substance generates fluorescence. Thus, the blue light emitted by the light emitting diode and the light emitted as the fluorescent substance fluoresces blend to produce white light from the LED chip 50.

The LED chip 50 may for example be formed by applying a YAG (yttrium aluminum garnet) base fluorescent substance to the surface of a GaN base light emitting diode, an InGaN base light emitting diode, and the like.

A light source support 52 is a plate member disposed such that one surface thereof faces the light entrance plane 30d or 30e, which is a lateral end face of the light guide plate 30 at which the light guide plate 30 is thinnest.

The light source support 52 carries the LED chips 50 on its lateral plane (30d or 30e) facing the light entrance plane of the light guide plate 30 so that the LED chips 50 are spaced at given intervals from each other. Specifically, the LED chips 50 constituting the light source 28 are arrayed along the length of the first light entrance plane 30d or the second light entrance plane 30e of the light guide plate 30 to be described and secured to a light source support 52.

The light source support 52 is formed of a metal having a good heat conductance as exemplified by copper and aluminum and also acts as a heat sink to absorb heat generated by the LED chips 50 and releases the heat to the outside. The light source support 52 may be equipped with fins to provide a larger surface area for an increased heat dissipation effect or heat pipes to transfer heat to a heat dissipation member.

As illustrated in FIG. 4B, the LED chips 50 according to this embodiment each preferably have a rectangular shape such that the sides normal to the direction in which the LED chips 50 are arrayed are shorter than the sides lying in the direction in which the LED chips 50 are arrayed or, in other words, the sides lying in the direction of thickness of the light guide plate 30 to be described, i.e., the direction normal to the light exit plane 30a, are preferably the shorter sides. Expressed otherwise, the LED chips 50 each have a shape defined by b>a where “a” denotes the length of the side perpendicular to the light exit plane 30a of the light guide plate 30 and “b” denotes the length of the side in the array direction. Now, given “q” as the distance by which the arrayed LED chips 50 are spaced apart from each other, then q>b holds. Thus, the length “a” of the side of the LED chips 50 perpendicular to the light exit plane 30a of the light guide plate 30, the length “b” of the side in the array direction, and the distance “q” by which the arrayed LED chips 50 are spaced apart from each other preferably have a relationship satisfying q>b>a.

Providing the LED chips 50 each having the shape of a rectangle allows a thinner design of the light source to be achieved while producing a large amount of light. A thinner light source 28, in turn, permits reduction of thickness of the backlight unit. Further, the number of LED chips that need to be arranged may be reduced.

While the LED chips 50 each preferably have a rectangular shape with the shorter sides lying in the direction of the thickness of the light guide plate 30 for a thinner design of the light source 28, the present invention is not limited thereto, allowing the LED chips to have any shape as appropriate such as a square, a circle, a polygon, and an ellipse.

While the LED chips 50, arranged in a single row, has a monolayered structure in the embodiment under discussion, the present invention is not limited thereto; one may use multilayered LED arrays for the light source comprising LED arrays each carrying LED chips 50 on the array base 54. Where the LEDs are thus stacked, more LED arrays can be stacked when the LED chips 50 are each adapted to have a rectangular shape and the LED arrays are each adapted to have a reduced thickness. Where the LED arrays are stacked to form a multilayer structure, that is to say, where more LED arrays (LED chips) are packed into a given space, a large amount of light can be generated. Preferably, the above inequality also applies to the distance separating the LED chips of one LED array from the LED chips of the other LED arrays in adjacent layers. Expressed otherwise, the LED arrays preferably are stacked such that the LED chips are spaced a given distance apart from the LED chips of the LED arrays in adjacent layers.

Next, the transmittance adjusting members 40 will be described.

The transmittance adjusting members 40 are each formed of a circular dot having a given transmittance and provided to diffuse the light admitted through the light entrance planes of the light guide plate 30 and emit the light through the light exit plane 30a and also to reduce the unevenness in the emitted light. As illustrated in FIGS. 2 and 3, a plurality of the transmittance adjusting members 40 are provided by printing or other means on the rear plane (the first inclined plane 30b, the second inclined plane 30c, and the curved portion 30h) of the light guide plate 30 in a given pattern.

The transmittance adjusting members 40 may be scattering reflection members and formed, for example, of pigments such as silica, titanium oxide, and zinc oxide that diffuse light, or a coating containing a kind of beads such as resin, glass, and zirconia, as well as a binder, and a roughened surface pattern produced by applying fine asperity machining or polishing to the surface. Alternatively, one may use materials having a high reflectance and a low light absorbance, including metals such as Ag and Al.

Alternatively, common white ink such as ink used for screen printing and offset printing may be used to form the transmittance adjusting members 40. Examples thereof include ink prepared by dispersing titanium oxide, zinc oxide, zinc sulfate, barium sulfate, or the like into an acryl-based binder, a polyester-based binder, chloroethene-based binder, or the like, or ink prepared by mixing silica with titanium oxide to provide diffusivity.

The transmittance adjusting members 40 are arranged on the rear plane of the light guide plate 30 in a given pattern such that the pattern density varies with the position in the surface.

The transmittance adjusting members 40 are not provided in a given region on the rear plane of the light guide plate 30 close to the light entrance planes (30d, 30e).

Specifically, the transmittance adjusting members 40 are not provided in a region extending a distance of Lmfp from the first light entrance plane 30d of the first inclined plane 30b, where the Lmfp is a mean free path of the luminous flux that has entered the light guide plate 30 containing scattering particles dispersed therein, and in a region extending the distance of Lmfp from the second light entrance plane 30e of the second inclined plane 30c.

Now, let r be the radius of the scattering particles, and Np the particle density of the scattering particles, then the mean free path Lmfp of the luminous flux inside the light guide plate 30 is expressed as Lmfp=1/(π·r²·Np), which denotes a distance the luminous flux can travel without being diffused. This means that the luminous flux admitted through the light entrance planes (30d, 30e) is diffused once on average while it travels the distance of Lmfp.

Because the light admitted through the light entrance planes (30d, 30e) is thus sufficiently diffused by the scattering particles kneaded and dispersed into the light guide plate 30 before reaching the region where the transmittance adjusting members 40 are provided, the light emitted from the region where the transmittance adjusting members 40 are provided is sufficiently diffused and hence is unevenness in luminance is reduced.

Because the transmittance adjusting members 40 are provided on the surface of the rear plane or the light exit plane 30a of the light guide plate 30, the luminous flux tends to be diffused by the transmittance adjusting members 40 with a directivity in a direction normal to the light exit plane 30a, i.e., the direction in which the light is emitted. Accordingly, diffusing the light with the transmittance adjusting members 40 also increases the light amount emitted.

By contrast, the luminous flux tends to be diffused by the scattering particles kneaded and dispersed in the light guide plate 30 with a directivity in forward direction. In other words, the light admitted through the light entrance plane is diffused inwardly of the light guide plate without changing its direction. Therefore, the light can be diffused in such a manner that the light amount of the light emitted through the light exit plane is made relatively small near where the light is admitted and increased appropriately as the light travels inwardly of the light guide plate. Accordingly, when the light is diffused by the scattering particles, the increase in the light amount near where the light is admitted can be made smaller than when the diffusion is effected by the transmittance adjusting members.

Thus, the light admitted through the light entrance planes (30d, 30e) travels in a small emission amount as it is diffused through the region extending the distance L_{mfp} where the transmittance adjusting members 40 are not provided and emitted in sufficiently diffused state in the region where the transmittance adjusting members 40 are provided, so that the unevenness in luminance of the light emitted through the light exit plane 30a can be reduced and the light amount near the center of the light guide plate can be relatively increased, achieving a luminance distribution that is high in a range near the middle.

In a typical backlight unit, the end portions of the light exit plane are covered by a housing and the light emitted from these covered portions is not used. Therefore, reducing the emitted light amount in the region lying in the region extending the distance Lmfp from the light entrance planes (30d, 30e) and increasing the emitted light amount near the center of the light guide plate increase the light use efficiency.

The mean free path Lmfp of the luminous flux is determined, as described above, by the radius r and the particle density Np of the scattering particles kneaded and dispersed into the light guide plate 30. As described above, preferable ranges of the radius and the particle density of the scattering particles for obtaining a preferable luminance distribution and a preferable light use efficiency of the emitted light vary with the dimensions of the light guide plate (light guiding length) (see the expression 4).

Therefore, with a mere configuration where the transmittance adjusting members are not provided in given regions of the light guide plate near where the light is admitted, it is possible depending on the dimensions of the light guide plate that the admitted light, not sufficiently diffused, reaches the region provided with the transmittance adjusting members and is emitted with unevenness in luminance.

According to the invention, however, the mean free path Lmfp of the luminous flux determined by the radius r and the particle density Np of the scattering particles kneaded and dispersed into the light guide plate 30 is calculated and the regions not provided with the transmittance adjusting members 40 are determined based on the mean free path thus obtained. Therefore, this method can be applied to light guide plates of various dimensions having different radius and particle density of the scattering particles.

As described above, the mean free path Lmfp of the luminous flux inside the light guide plate is Lmfp=1/(π·r²·Nₚ). Because a volume (particle density (volume percentage)) VIp of particles in unit volume is expressed as VIp ═Nₚ·(4/3)·π·r³, the relationship between the mean free path Lmfp and the radius r and the particle density VIp of the scattering particles is expressed as VIp=Np·(4/3)·(r/L_{mfp}). Further, conversion of the value of the particle density (volume percentage) VIp into particle density Vp in weight percentage can be achieved by multiplication of the ratio of the base material and the particles. Thus, given a base material formed of PMMA (specific gravity 1.32) and particles formed of silicone (specific ratio 1.19), Vₚ=(4/3)·(r/L_{mfp})×1.19/1.32.

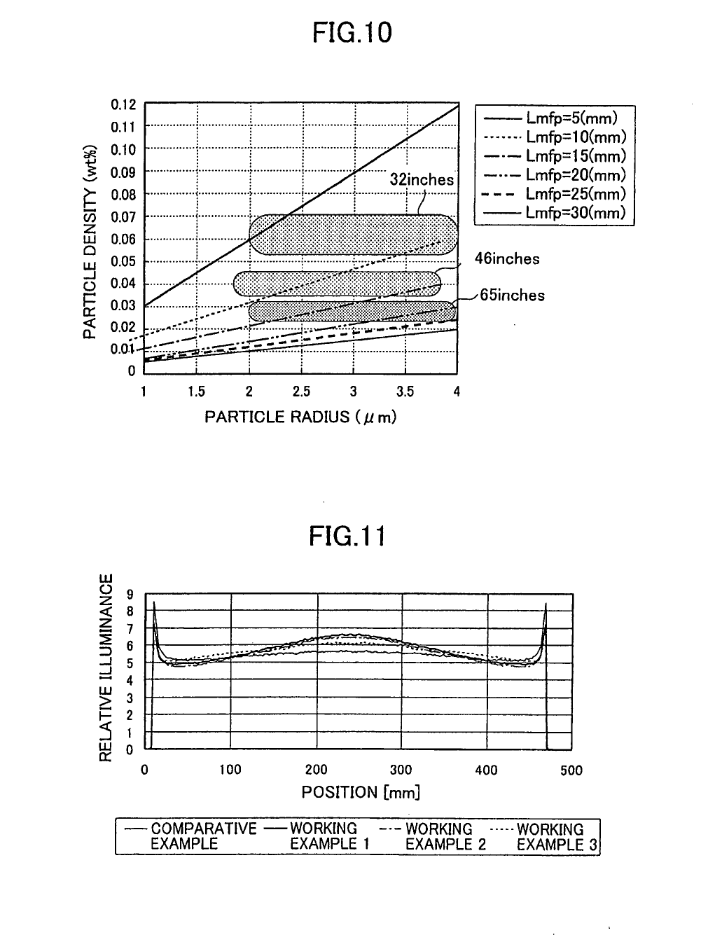

FIG. 10 is a graph illustrating a relationship between the mean free path L_{mfp} and the radius r of scattering particles and the particle density Vₚ. The graph illustrated in FIG. 10 shows a case where the base material is formed of PMMA and the particles are formed of silicone.

In the graph, the thick solid line indicates a mean free path L_{mfp} of 5 mm, the broken line indicates a mean free path L_{mfp} of 10 mm, the chain line indicates a mean free path L_{mfp} of 15 mm, the chain double-dashed line indicates a mean free path L_{mfp} of 20 mm, the thick broken line indicates a mean free path L_{mfp} of 25 mm, and the thin solid line indicates a mean free path L_{mfp} of 30 mm.

FIG. 10 also shows ranges of practical particle radius and particle density of scattering particles (weight percentage) where the luminance distribution of the light emitted through the light exit plane of the light guide plates having various dimensions is optimized.

Specifically, as illustrated in FIG. 10, when a 32-inch light guide plate (the screen measuring 400 mm in the light guiding direction) is used, a practical radius of scattering particles is about 2 μm to 4 μm and a practical particle density thereof is 0.053 wt % to 0.07 wt %, making the mean free path Lmfp 5 mm to 10 mm. Accordingly, the transmittance adjusting members 40 are preferably not provided in a region of 5 mm to 10 mm from the light entrance planes.

When a 46-inch light guide plate (the screen measuring 573 mm in the light guiding direction) is used, a practical radius of scattering particles is 2 μm to 4 μm and a practical particle density thereof is 0.035 wt % to 0.045 wt %, making the mean free path Lmfp 10 mm to 15 mm. Accordingly, the transmittance adjusting members 40 are preferably not provided in a region of 10 mm to 15 mm from the light entrance planes.

When a 65-inch light guide plate (the screen measuring 809 mm in the light guiding direction) is used, a practical radius of scattering particles is 2 μm to 4 μm and a practical particle density thereof is 0.024 wt % to 0.032 wt %, making the mean free path Lmfp 10 mm to 25 mm. Accordingly, the transmittance adjusting members 40 are preferably not provided in a region of 10 mm to 25 mm from the light entrance planes.

The transmittance adjusting members 40 may be arranged in any appropriate pattern as desired in a region excluding those where they are not to be provided; the pattern may be uniform or may grow denser toward the center of the light guide plate.

Now, let ρ(x,y) be the pattern density in an arbitrary position (x,y) and F(x,y) the relative luminance of light emitted from an arbitrary position in the light exit plane (the plane on the side closer to the liquid crystal display panel 4) of a backlight unit not provided with the transmittance adjusting members 40. Then, the relationship between the pattern density ρ(x,y) and the relative luminance F(x,y) preferably satisfies the following expression (5).

ρ(x,y)=c{F(x,y)−Fₘᵢₙ}/(Fₘₐₓ−Fₘᵢₙ) (5)

In the expression (5), Fₘₐₓ denotes a maximum luminance and

Fₘᵢₙ denotes a minimum luminance of the light emitted through the light exit plane of the backlight unit not provided with the transmittance adjusting members 40. The maximum luminance Fmax serves as a reference point (Fₘₐₓ=1) for determining the relative luminance F(x,y).

In the expression (5), c denotes a maximum density, and preferably in a range of 0.5≦c≦1.

When the transmittance adjusting member arrangement is designed according to the above expression, there may be cases where unevenness in luminance is seen depending on the observation angle. To make improvements in this regard, the calculated density distribution is preferably added with “uniform density distribution (bias density ρb).” This reduces unevenness in luminance and eliminates or reduces the angle dependency of the unevenness in luminance.

The bias density ρb is preferably 0.01 to 1.50 (1% to 150%). Where the arrangement density exceeds 1 (100%), the transmittance adjusting members are provided in a dual layer.

Specifically, on the transmittance adjusting members placed over the whole surface are further disposed transmittance adjusting members having an arrangement density of (ρb−1).

The pattern density ρ(x,y) herein designates an occupancy in unit area (1 mm²) of transmittance adjusting members 40 disposed in an arbitrary position (x,y): when ρ(x,y)=1, the transmittance adjusting members are provided on the whole surface of unit area; when ρ(x,y)=0, no transmittance adjusting members are provided in unit area.

Providing the transmittance adjusting members 40 so as to satisfy the pattern density ρ(x,y) in the above expression (5) enables reduction of a mean luminance of the light emitted through the light exit plane of the backlight unit and reduction of the unevenness in luminance.

The transmittance adjusting members according to this embodiment each have a circular shape according to this embodiment but may have any shape as appropriate according to the invention such as a triangle, a hexagon, a circle, and an ellipse.

The transmittance adjusting members according to this embodiment are provided on the rear plane of the light guide plate but the invention is not limited to this configuration, and they may be provided on the light exit plane of the light guide plate.

Further, the position where the transmittance adjusting members 40 are provided is not limited to the surfaces of the light guide plate; the transmittance adjusting members may be arranged on a transparent film and this transparent film may be provided on the rear side or the light exit plane side of the light guide plate, or alternatively may be arranged on a reflection film or a sheet constituting the optical member units.

Next, the optical member unit 32 will be described.

The optical member units 32 are provided to further reduce the unevenness in luminance and unevenness in illuminance of the illumination light emitted through the light exit plane 30a of the light guide plate 30 before the illumination light is emitted through the light exit plane 24a of the main body of the lighting device 24. As illustrated in FIG. 2, the optical member unit 32 comprises a diffusion sheet 32a for diffusing the illumination light emitted through the light exit plane 30a of the light guide plate 30 to reduce unevenness in luminance and unevenness in illuminance; a prism sheet 32b having micro prism arrays formed thereon parallel to the lines where the light exit plane 30a and the light entrance planes 30d, 30e meet; and a diffusion sheet 32c for diffusing the illumination light emitted through the prism sheet 32b to reduce unevenness in luminance and unevenness in illuminance.

The diffusion sheets 32a and 32c and the prism sheet 32b are not specifically limited and may be known diffusion sheets and a known prism sheet. The diffusion sheets 20a and 20c and the prism sheet 20b may be, for example, the diffusion sheets and the prism sheet disclosed in paragraphs [0028] through [0033] of JP 2005-234397 A by the Applicant of the present application.

While the optical member unit in the embodiment under discussion comprises the two diffusion sheets 32a and 32c and the prism sheet 32b between the two diffusion sheets, there is no specific limitation to the order in which the prism sheet and the diffusion sheets are arranged or the number thereof to be provided. Nor are the prism sheet and the diffusion sheets specifically limited, and use may be made of various optical members, provided that they are capable of reducing the unevenness in luminance and unevenness in illuminance of the illumination light emitted through the light exit plane 30a of the light guide plate 30.

Further, the optical member unit may be adapted to have a two-layer structure formed using one sheet each of the prism sheet and the diffusion sheet or two diffusion sheets only.

Next, the reflection film 34 will be described.

The reflection film 34 is provided to reflect light leaking through the rear plane (the first inclined plane 30b, the second inclined plane 30c, and the curved portion 30h) of the light guide plate 30) back into the light guide plate 30 and helps enhance the light use efficiency. The reflection film 34 has a shape corresponding to the rear plane of the light guide plate 30 and is formed so as to cove the rear plane. In this embodiment, the reflection film 34 is formed into a shape contouring the rear plane having the substantially V-shaped cross section of the light guide plate 30 with a curved bent portion as illustrated in FIG. 2.

The reflection film 34 may be formed of any material as desired, provided that it is capable of reflecting light leaking through the rear plane of the light guide plate 30. The reflection film 34 may be formed, for example, of a resin sheet produced by kneading, for example, PET or PP (polypropylene) with a filler and then drawing the resultant mixture to form voids therein for increased reflectance; a sheet with a specular surface formed by, for example, depositing aluminum vapor on the surface of a transparent or white resin sheet; a metal foil such as an aluminum foil or a resin sheet carrying a metal foil; or a thin sheet metal having a sufficient reflective property on the surface.

Upper light guide reflection films 36 are disposed between the light guide plate 30 and the diffusion sheet 32a, i.e., on the side of the light guide plate 30 closer to the light exit plane 30a, covering the light sources 28 and the end portions of the light exit plane 30a, i.e., the end portion thereof closer to the first light entrance plane 30d and the end portion thereof closer to the second light entrance plane 30e. Thus, the upper light guide reflection films 36 are disposed to cover an area extending from part of the light exit plane 30a of the light guide plate 30 to a part of the light source support 52 of the light sources 28 in a direction parallel to the direction of the optical axis. Briefly, two upper light guide reflection films 36 are disposed respectively at both end portions of the light guide plate 30.

The upper light guide reflection films 36 thus provided prevent light emitted by the light sources 28 from failing to enter the light guide plate 30 and leaking toward the light exit plane 30a.

Thus, light emitted from the light sources 28 is efficiently admitted through the first light entrance plane 30d and the second light entrance plane 30e of the light guide plate 30, increasing the light use efficiency.

The upper light guide reflection films 36 may be formed of any of the above-mentioned materials used to form the reflection film 34.

The lower light guide reflection films 38 are disposed on the side of the light guide plate 30 closer to the rear plane (the first inclined plane 30b, the second inclined plane 30c, and the curved portion 30h) so as to cover a part of the light sources 28. The ends of the lower light guide reflection films 38 closer to the center of the light guide plate 30 are connected to the reflection film 34.

The lower light guide reflection films 38 may be formed of any of the above-mentioned materials used to form the reflection film 34.

The lower light guide reflection films 38 thus provided prevent light emitted by the light sources 28 from failing to enter the light guide plate 30 and leaking toward the rear plane of the light guide plate 30.

Thus, light emitted from the light sources 28 is efficiently admitted through the first light entrance plane 30d and the second light entrance plane 30e of the light guide plate 30, increasing the light use efficiency.

While the reflection film 34 is connected to the lower light guide reflection films 38 in the embodiment under discussion, their configuration is not limited this way; they may be formed of separate materials.

The shapes and the widths of the upper light guide reflection films 36 and the lower light guide reflection films 38 are not limited specifically, provided that light emitted by the light sources 28 is reflected toward the first light entrance plane 30d or the second light entrance plane 30e so as to be admitted into the light guide plate 30 and guided toward the center of the light guide film 30.

While, in the embodiment under discussion, the upper light guide reflection films 36 are disposed between the light guide plate 30 and the diffusion sheet 32a, the location of the upper light guide reflection films 36 is not limited this way; it may be disposed between the sheets constituting the optical member unit 32 or between the optical member unit 32 and the upper housing 44.

Next, the housing 26 will be described.

As illustrated in FIG. 2, the housing 26 accommodates and supports therein the main body of the lighting device 24 by holding the sides of the light guide plate facing the light exit plane and the rear plane to secure the main body of the lighting device. The housing 26 comprises the lower housing 42, the upper housing 44, and the support members 48.

The lower housing 42 is open at the top and has a configuration comprising a bottom section and lateral sections provided upright on the four sides of the bottom section. In brief, it has substantially the shape of a rectangular box open on one side. As illustrated in FIG. 2, the bottom side and the lateral sides of the housing 42 support the lighting device 24 placed therein from above on the underside and on the lateral sides and covers the faces of the lighting device 24 except the light exit plane 24a, i.e., the plane opposite from the light exit plane 24a of the lighting device 24 (rear plane) and the lateral sides.

The upper housing 44 has the shape of a rectangular box; it has an opening at the top smaller than the rectangular light emission plane 24a of the main body of the lighting device 24 and is open on the bottom side.

As illustrated in FIG. 2, the upper housing 44 is placed from above the main body of the lighting device 24 and the lower housing 42, that is, from the light exit plane side, to cover the main body of the lighting device 24 and the lower housing 42, which holds the former, as well as four lateral sections 22b.

The support members 48 are rod members each having an identical cross section normal to the direction in which they extend throughout their length.

As illustrated in FIG. 2, the support members 48 are provided between the reflection film 34 and the lower housing 42, more specifically, between the reflection film 34 and the lower housing 42 close to the end of the first inclined plane 30b of the light guide plate 30 on which the first light entrance plane 30d is located and close to the end of the second inclined plane 30c of the light guide plate 30 on which the second light entrance plane 30e is provided. The support members 48 thus secure the light guide plate 30 and the reflection film 34 to the lower housing 42 and support them.

While the support members are discretely provided in the embodiment under discussion, the invention is not limited thereto; they may be integrated with the lower housing 42 or the reflection film 34.

The positions of the support members are also not limited; the support members may be provided in any positions between the reflection film 34 and the lower housing 42.

The support members 48 may be given various shapes and formed of various materials without specific limitations. For example, two or more of the support members may be provided at given intervals.

The backlight unit 20 is basically configured as described above.

In the backlight unit 20, light emitted by the light sources 28 provided on both sides of the light guide plate 30 strikes the light entrance planes, i.e., the first light entrance plane 30d and the second light entrance plane 30e, of the light guide plate 30. Then, the light admitted through the respective planes is scattered by the scatterers contained inside the light guide plate 30 in the region near the light entrance planes and by the scatterers and the transmittance adjusting members 40 in the region provided with the transmittance adjusting members 40, as the light travels through the inside of the light guide plate 30 and exits, directly or after being reflected by the rear plane (the first inclined plane 30, the second inclined plane 30c, and the curved portion 30h), through the light exit plane 30a. A part of the light leaking through the rear plane is reflected by the reflection film 34 to enter the light guide plate 30 again.

Thus, light emitted through the light exit plane 30a of the light guide plate 30 is transmitted through the optical member 32 and emitted through the light emission plane 24a of the main body of the lighting device 24 to illuminate the liquid crystal display panel 12.

The liquid crystal display panel 12 uses the drive unit 14 to control the transmittance for the light according to the position so as to display characters, figures, images, etc. on its surface.

Now, the planar lighting device (backlight unit) 20 will be described in greater detail by referring to specific examples.

In this embodiment, a computer simulation was conducted using a light guide plate where the luminous flux has a mean free path of Lmfp to obtain light use efficiency and a relative illuminance distribution of light emitted from a planar lighting device having regions each extending a distance of Lmfp from the respective light entrance planes that are not provided with the transmittance adjusting members 40.

The simulation used a planar lighting device that is used for a 37-inch screen.

Specifically, this example of the light guide plate had a following configuration: the length from the first light entrance plane 30d to the second light entrance plane 30e measured 480 mm; the length from the light exit plane 30a to the rear plane at the bisector α, i.e., a maximum thickness of the light guide plate, measured 3.5 mm; the thickness at the first light entrance plane 30d and the second light entrance plane 30e, i.e., a minimum thickness of the light guide plate, measured 2.0 mm; and the radius of curvature R of the curved portion 30h of the rear plane measured 25000 mm. The scattering particles kneaded and dispersed into the light guide plate had a radius of 3.5 μm and a particle density Vp of 0.035 wt %. The mean free path L_{mfp} of the luminous flux inside the light guide plate L_{mfp} is about 10 mm.

The transmittance adjusting members 40 were formed by a dot emboss pattern and arranged on the rear plane of the light guide plate in a checkered pattern.

Using the planar lighting device configured as above, measurements were made of the relative illuminance distribution and light use efficiency of the embodiment 1, embodiment 2, and embodiment 3 each having the transmittance adjusting members 40 provided in an area excluding a region extending a distance of 10 mm, 7.5 mm, and 5 mm from the light entrance planes, respectively. Also measured was a planar lighting device wherein the transmittance adjusting members 40 were provided over the whole area of the rear plane as a comparative example.

The light use efficiency herein denotes the ratio of the sum of intensity of light emitted through the entire light exit plane of a light guide plate of interest to that of the comparative example of the light guide plate, i.e., the light guide plate having the transmittance adjusting members 40 provided over the whole rear plane, with the intensity of the light measured with the comparative example taken to be 100%.

Table 2 gives measurements of light use efficiency; FIG. 11 illustrates relative illuminance distributions. In FIG. 11, the vertical axis indicates the relative illuminance, and the horizontal axis indicates the distance [mm] from the center of the light guide plate. In the graph, the working example 1 is indicated in a thick solid line, the working example 22 in a broken line, the working example 23 in a chain line, and the comparative example 21 in a thin solid line.

TABLE 2

| | Working | Working | Working | Comparative |
|---|---|---|---|---|
| | example 1 | example 2 | example 3 | example |
| Region without | 10 | 7.5 | 5 | — |
| transmittance | | | | |
| adjusting members | | | | |
| Distance (mm) from | | | | |
| light entrance plane | | | | |
| Light use efficiency | 106 | 104 | 102 | 100 |
| (%) | | | | |

As shown in Table 2 and in FIG. 11, when the mean free path of the luminous flux inside the light guide plate 30 is Lmfp, the configuration where the transmittance adjusting members 40 are not provided in the regions extending the distance of L_{mfp} from the light entrance planes (Embodiments 1, 2, and 3) permits achieving a light use efficiency that is as high as or greater than is possible with a configuration (comparative example) where the transmittance adjusting members 40 are provided also in regions close to the light entrance planes and obtaining an illuminance distribution that is high in a range near the middle.

While the above embodiment uses a light guide plate having scattering particles evenly dispersed throughout the whole region thereof, the invention is not limited this way, and the particle density may be higher near the light entrance planes than in the other regions.

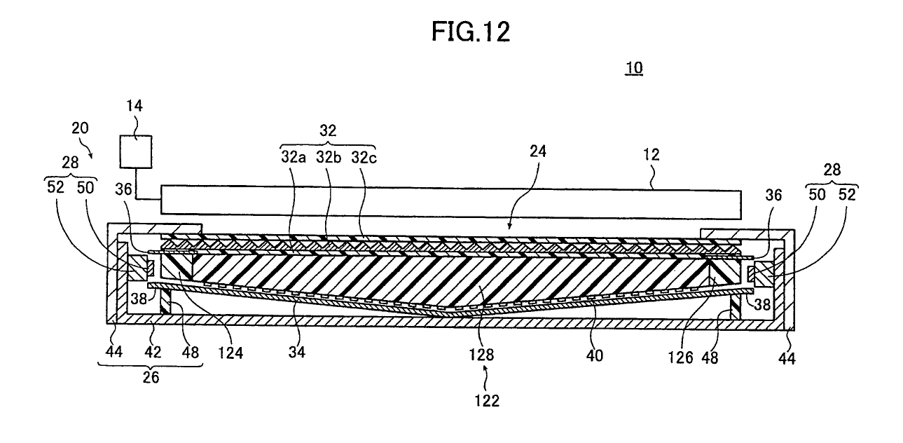

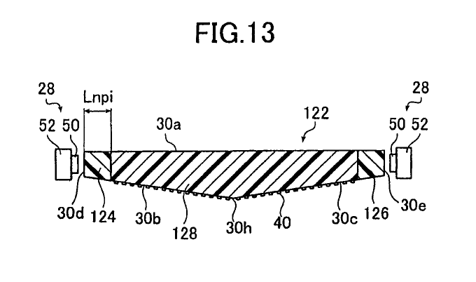

FIG. 12 is a schematic sectional view illustrating a part of another example of the backlight unit of the invention; FIG. 13 is a schematic sectional view illustrating a light guide plate, light sources and transmittance adjusting members used in the backlight unit shown in FIG. 12. The backlight unit 12 illustrated in FIG. 12 has the same configuration as the backlight unit 20 illustrated in FIG. 2 except for a light guide plate 122 provided in lieu of the light guide plate 30. In the following, like components will be given like characters, and the description will be focused on the components different between these backlight units.

The light guide plate 122 illustrated in FIG. 13 comprises a first light entrance section 124 extending a distance of Lnpi from the light entrance plane 30d, a second light entrance section 126 extending a distance of Lnpi from the light entrance plane 30e, and a light exit section 128 between the first light entrance section 124 and the second light entrance section 126. The first light entrance section 124, the second light entrance section 126, and the light exit section 128 have different particle concentrations (particle densities) of scattering particles, the particle concentration differing at the interfaces between them parallel to the light entrance planes (30d, 30e). These interfaces are virtual ones such that the first light entrance section 124, the second light entrance section 126, and the light exit section 128 are unitary.

Now, let Nₚᵢ be the particle density of the scattering particles in the first light entrance section 124 and the second light entrance section 126, and Np the particle density of the scattering particles in the light exit section 128. Then Nₚᵢ and Np have a relationship expressed by Nₚᵢ>Nₚ. Thus, the light guide plate 122 has a higher particle density in the light entrance sections (124, 126) than in the light exit section 128.

In order to secure a preferable illuminance distribution and light use efficiency with a larger light guide plate, the particle density of the scattering particles dispersed inside the light guide plate needs to be low as described above. However, a low particle density of the scattering particles necessarily elongates the mean free path of the luminous flux inside the light guide plate and, hence, the distance it takes the light admitted from the light entrance planes to be sufficiently diffused, possibly allowing occurrence of unevenness in luminance in the emitted light. On the other hand, if a region for sufficiently diffusing the admitted light is to be secured, the whole device needs to be enlarged.

By contrast, the configuration where the first light entrance section 124 and the second light entrance section 126 have a higher particle density of scattering particles than the light exit section 128 allows a short mean free path of the luminous flux in regions near the light entrance planes (light entrance sections) even with a large light guide plate. Thus, the light admitted from the light entrance planes can be sufficiently diffused, so that the unevenness in luminance in the emitted light can be reduced. Further, the region for sufficiently diffusing the admitted light can be secured without the need to enlarge the whole device.

Now, let Lmfpi be the mean free path of the luminous flux inside the light entrance sections (124, 126), then a width Lnpi of the light entrance sections is preferably Lₙₚᵢ=L_{mfpi}.

When the width of the light entrance sections is shorter than the mean free path Lmpfi, the admitted light may not be sufficiently diffused. On the other hand, when the width of the light entrance sections is longer than the mean free path L_{mpfi}, this may affect the illuminance distribution of the emitted light emitted through the light exit plane 30a.

However, when the width Lnpi of the light entrance sections is equal to the mean free path Lmfpi of the luminous flux inside the light entrance section, the admitted light can be sufficiently diffused to prevent occurrence of unevenness in luminance and minimize the effects on the illuminance distribution of the light emitted from the light exit plane 30a.

Specifically, the particle density in the light entrance section is preferably in a range of 0.02 wt % inclusive to 0.2 wt % inclusive, and the width Lnpi of the light entrance sections is in a range of 5 mm inclusive to 30 mm inclusive, and more preferably 10 mm inclusive to 20 mm inclusive.

As illustrated in FIG. 12, the upper light guide reflection films 36 are preferably so disposed as to cover the whole surfaces of the light entrance sections (124, 126) on the side of the light guide plate 122 closer to the light exit plane 30a. Further, the upper light guide reflection films 36 are preferably provided in positions corresponding to the frame portions around the opening of the upper housing 44, that is, in positions not observable from the opening of the upper housing 44 when seen from a direction normal to the light exit plane 30a.

With the upper light guide reflection films so provided as to cover the whole surfaces of the light entrance sections of the light guide plate and disposed in positions not observable from the opening of the upper housing 44, the borders between the light entrance sections and the light exit section can be made unobservable in the light emitted through the light exit plane.

Where the light entrance sections and the light exit section have different particle densities and the light guide plate comprises a plurality of layers superposed in the direction normal to the light exit plane, the light entrance sections may be formed of a single layer while the light exit section may be formed of a plurality of layers, or both the light entrance sections and the light exit section may be formed of a plurality of layers. Where the light guide plate (light entrance sections) is formed of a plurality of layers, the mean free path Lmfp and other factors may be obtained using the combined particle concentration (combined particle density).

Note that the combined particle concentration (combined particle density) herein denotes a density of scattering particles expressed using an amount of scattering particles added (combined) in a direction perpendicular to the light exit plane at a position spaced apart from one light entrance plane toward the other on the assumption that the light guide plate is a flat plate of which the thickness is a thickness at the light entrance planes throughout the light guide plate. In other words, the combined particle density denotes an amount of scattering particles in unit volume or a weight percentage of the scattering particles in relation to the base material added in a direction perpendicular to the light exit plane at a position spaced apart from a light entrance plane on the assumption that the light guide plate is a flat plate of which the thickness is a thickness at the light entrance planes throughout the light guide plate.

While the planar lighting device of the invention has been described above in detail, the present invention is not limited in any manner to the above embodiments and various improvements and modifications may be made without departing from the spirit of the invention.

For example, the base material of the light guide plate near the light entrance planes (transparent resin) may be formed of a material having a higher refractive index than the base material used to form the other region. Thus, the Fresnel loss occurring as the light emitted from the light source enters the light guide plate can be reduced.

Further, a substance having substantially the same refractive index as the base material of the light guide plate may be filled between the light source and the light entrance planes of the light guide plate. Thus, air interface is eliminated, the light emitted from the light source can be prevented from expanding, and Fresnel loss can be reduced.

The light guide plate may be fabricated by mixing a plasticizer into a transparent resin of the light guide plate.

Fabricating the light guide plate from a material thus prepared by mixing a transparent resin and a plasticizer provides a flexible light guide plate, allowing the light guide plate to be deformed into various shapes. Accordingly, the surface of the light guide plate can be formed into various curved surfaces.

Where the light guide plate is given such flexibility, a backlight unit using the light guide plate as described above can even be mounted to a wall having a curvature when used, for example, for a display board employing ornamental lighting (illuminations). Accordingly, the backlight unit can be used for a wider variety of applications and in a wider application range including ornamental lighting and POP (point-of-purchase) advertising.

Said plasticizer is exemplified by phthalic acid esters, or, specifically, dimethyl phthalate (DMP), diethyl phthalate (DEP), dibutyl phthalate (DBP), di(2-ethylhexyl) phthalate (DOP (DEHP)), di-n-octyl phthalate (DnOP), diisononyl phthalate (DINP), dinonyl phthalate (DNP), diisodecyl phthalate (DIDP), phthalate mixed-base ester (C6 to C11) (610P, 711P, etc.) and butyl benzyl phthalate (BBP). Besides phthalic acid esters, said plasticizer is also exemplified by dioctyl adipate (DOA), diisononyl adipate (DINA), dinormal alkyl adipate (C6, 8, 10) (610A), dialkyl adipate (C7, 9) (79A), dioctyl azelate (DOZ), dibutyl sebacate (DBS), dioctyl sebacate (DOS), tricresyl phosphate (TCP), tributyl acetylcitrate (ATBC), epoxidized soybean oil (ESBO), trioctyl trimellitate (TOTM), polyesters, and chlorinated paraffins.

The light guide plate may be adapted so as to emit light through the rear plane, the plane opposite from the light exit plane, in addition to the light exit plane, that is, the light guide plate may be adapted to emit light from both sides. The backlight unit, thus adapted to emit light from both sides, can be used for a wider variety of applications including ornamental lighting (illumination) and POP (point-of-purchase) advertising.

Although the light guide plate according to the above embodiments is of a type comprising two light sources disposed adjacent two respective light entrance planes to admit light through both sides of the light guide plate, the invention is not limited to such a configuration; the light guide plate may be of a type comprising a single light source disposed adjacent one light entrance plane to admit light through one side of the light guide plate. Reduction in number of light sources permits reduction in number of component parts and hence in manufacturing costs.

Alternatively, light sources may be also provided opposite the shorter sides of the light exit plane of the light guide plate in addition to the two light entrance planes. Increasing the number of light sources permits enhancing the intensity of light emitted by the light guide plate.

What is claimed is:

1. A planar lighting device comprising:
a light guide plate including a rectangular light exit plane, at least one light entrance plane provided on a side of the light exit plane, and a rear plane that is a plane opposite from the light exit plane, the light guide plate containing scattering particles dispersed therein,
a light source disposed opposite the light entrance plane, and
transmittance adjusting members provided on a side of the light guide plate closer to the rear plane or on a side closer to the light exit plane, or on both of these sides,
wherein the transmittance adjusting members are not provided in a region extending a distance of Lmfp from an end of the light guide plate closer to the light entrance plane in a direction normal to the light entrance plane, where Lmfp is a mean free path of luminous flux emitted from the light source and admitted in the light guide plate through the light entrance plane.

2. The planar lighting device according to claim 1, wherein 2≦Φ·Nₚ·L_{G}·K_{C}≦7 is satisfied, where Φ is a scattering cross section of the scattering particles dispersed in the light guide plate, Np is a particle density, LG is a light guiding length in a light's incident direction, and Kc is a correction coefficient, provided that Kc is in a range of 0.005 inclusive to 0.1 inclusive.

3. The planar lighting device according to claim 1, wherein a region extending a distance of Lnpi from the light entrance plane in a direction normal to the light entrance plane of the light guide plate is a light entrance section having a different particle density from a particle density in another region, and wherein Nₚᵢ>Nₚ is satisfied, where Npi is a particle density of the scattering particles dispersed in the light entrance section and Np is a particle density of the scattering particles dispersed in the other region.

4. The planar lighting device according to claim 3, wherein Lnpi=Lmfpi is satisfied, where Lmfpi is a mean free path of luminous flux in the light entrance section.

5. The planar lighting device according to claim 3, wherein a combined particle concentration in the light entrance section is in a range of 0.02 wt % inclusive to 0.2 wt % inclusive.

6. The planar lighting device according to claim 3, wherein a width Lnpi of the light entrance section satisfies 5 mm≦Lₙₚᵢ≦30 mm.

7. The planar lighting device according to claim 3 comprising a light guide reflection plate provided on a side of the light guide plate closer to the light exit plane in a position corresponding to the light source and the light entrance section so as to cover a whole surface of the light entrance section.

8. The planar lighting device according to claim 7, wherein the light guide reflection plate and the light entrance section are provided on the side of the light guide plate closer to the light exit plane of a housing accommodating the light guide plate and the light source in a position corresponding to a frame portion lying in a plane having an opening.

9. The planar lighting device according to claim 1, wherein the light entrance section is provided adjacent two opposite sides of the light exit plane.

10. The planar lighting device according to claim 9, wherein the light guide plate is a flat sheet.

11. The planar lighting device according to claim 9, wherein a thickness of the light guide plate gradually increases with an increasing distance from the light entrance plane.

12. The planar lighting device according to claim 1, wherein the light exit plane is a concave plane.

13. The planar lighting device according to claim 1, wherein the light guide plate comprises a plurality of layers superposed on each other in a direction normal to the light exit plane and having different densities of scattering particles.

14. A method of producing a planar lighting device comprising
a rectangular light exit plane, at least one light entrance plane provided on a side of the light exit plane, and a rear plane that is a plane opposite from the light exit plane, the light guide plate containing scattering particles dispersed therein.
a light source disposed opposite the light entrance plane, and
transmittance adjusting members provided on a side of the light guide plate closer to the rear plane or on a side closer to the light exit plane, or on both of these sides,
wherein the transmittance adjusting members are not provided in a region extending a distance of Lmfp from an end of the light guide plate closer to the light entrance plane in a direction normal to the light entrance plane, where L_{mfp} is a mean free path of luminous flux emitted from the light source and admitted in the light guide plate through the light entrance plane.
